(19) United States
(12) Patent Application Publication
(10) Pub. No.: US 2014/0269656 A1
(43) Pub. Date: Sep. 18, 2014

(54) MULTI-USER MULTIPLE-INPUT AND MULTIPLE-OUTPUT (MU-MIMO) TRANSMISSION METHOD AND SYSTEM IN WIRELESS LOCAL AREA NETWORK (WLAN)

(71) Applicant: Electronics and Telecommunications Research Institute, Daejeon (KR)

(72) Inventors: Jee Yon CHOI, Daejeon (KR); Jae Woo PARK, Daejeon (KR); Sok Kyu LEE, Daejeon (KR)

(73) Assignee: Electronics and Telecommunications Research Institute, Daejeon (KR)

(21) Appl. No.: 14/174,539

(22) Filed: Feb. 6, 2014

(30) Foreign Application Priority Data
Mar. 14, 2013 (KR) 10-2013-0027169

(51) Int. Cl. H04B 7/06; H04B 7/04

(52) U.S. Cl. CPC H04B 7/0617; H04B 7/0452
USPC 370/338

(57) ABSTRACT

Provided is a data transmission method and system in a wireless local area network (WLAN) supporting a multi-user multiple-input and multiple-output (MU-MIMO), the method including determining a type of a first frame to be transmitted to at least one reception terminal, setting, based on a result of the determining, user identification (ID) information indicating an order of the at least one reception terminal, transmitting the first frame to the at least one reception terminal corresponding to the user ID information, receiving, from the at least one reception terminal, a second frame corresponding to the first frame, extracting, based on the received second frame, a beamforming parameter of the at least one reception terminal, and transmitting, to a physical (PHY) layer, the user ID information and the beamforming parameter corresponding to the at least one reception terminal.

### CROSS-REFERENCE TO RELATED APPLICATION

This application claims the priority benefit of Korean Patent Application No. 10-2013-0027169, filed on Mar. 14, 2013, in the Korean Intellectual Property Office, the disclosure of which is incorporated herein by reference.

### BACKGROUND

1. Field of the Invention

The present invention relates to a multi-user multiple-input and multiple-output (MU-MIMO) transmission method and system in a wireless local area network (WLAN), and more particularly, to technology for transferring a beamforming parameter from a media access control (MAC) layer to a physical (PHY) layer in a WLAN supporting an MU-MIMO.

2. Description of the Related Art

With development in information and communication technology, varied wireless communication technology is also under development. A wireless local area network (WLAN) refers to technology for wirelessly connecting to the Internet at domestic, corporate, or predetermined service providing areas, using a portable terminal, for example, a personal digital assistant (PDA), a smart phone, a laptop computer, a portable multimedia player (PMP), and the like, based on wireless frequency technology.

Recently, in a wireless communication system, a multiple-input and multiple-output (MIMO) technology for transmitting and receiving data using at least two antennas is being generalized. A WLAN also enables at least two transmission antennas to be used from the Institute of Electrical and Electronics Engineers (IEEE) 802.11n standard. The IEEE 802.11n standard allows for use of up to four antennas, and the IEEE 802.11ac standard allows for use of up to eight antennas. For example, when a transmission terminal uses a great number of antennas in comparison to a reception terminal, a single transmission terminal may transmit different data to a plurality of reception terminals concurrently. Accordingly, in recent times, research is being conducted into more efficient MU-MIMO transmission.

### SUMMARY

According to an aspect of the present invention, there is provided a data transmission method in a wireless local area network (WLAN) supporting a multi-user multiple-input and multiple-output (MU-MIMO), the method including determining a type of a first frame to be transmitted to at least one reception terminal, setting, based on a result of the determining, user identification (ID) information indicating an order of the at least one reception terminal, transmitting the first frame to the at least one reception terminal corresponding to the user ID information, receiving, from the at least one reception terminal, a second frame corresponding to the first frame, extracting, based on the received second frame, a beamforming parameter with respect to the at least one reception terminal, and transmitting, to a physical (PHY) layer, the user ID information and the beamforming parameter corresponding to the at least one reception terminal.

The first frame may correspond to one of a beamforming report (BR)-poll frame and a null data packet announcement (NDPA) frame included in a sounding protocol.

The second frame may correspond to a BR frame included in a sounding protocol.

The setting may include setting, when the first frame is determined to be the NDPA frame, an ID value of the user ID information to be “0”.

The setting may include identifying, when the first frame is determined to be the BR-poll frame, an ID value of the user ID information, and increasing the ID value of the user ID information based on a predetermined value.

The at least one reception terminal may be included in a single MU-MIMO group.

The transmitting of the first frame may include transmitting the NDPA frame to a first reception terminal of the at least one reception terminal based on the user ID information, and transmitting the BR-poll frame to a remaining reception terminal of the at least one reception terminal based on the user ID information.

The determining may include terminating a sounding protocol when the first frame is determined to differ from the NDPA frame and the BR-poll frame.

According to another aspect of the present invention, there is also provided a user ID information mapping system in a MAC hardware layer of a WLAN supporting an MU-MIMO, the system including a first frame type determiner to determine a type of a first frame to be transmitted to at least one reception terminal, a user ID setting unit to set user ID information indicating an order of the at least one reception terminal based on a result of the determining, a first frame transmitter to transmit the first frame to the at least one reception terminal corresponding to the user ID information, a second frame receiver to receive a second frame corresponding to the first frame from the at least one reception terminal, a beamforming parameter extractor to extract a beamforming parameter with respect to the at least one reception terminal based on the received second frame, and a user ID information and beamforming parameter transmitter to transmit, to a PHY layer, the user ID information and the beamforming parameter corresponding to the at least one reception terminal.

The first frame may correspond to one of a BR-poll frame and an NDPA frame included in a sounding protocol.

The second frame may correspond to a BR frame included in a sounding protocol.

The user ID information setting unit may set an ID value of the user ID information to be “0” when the first frame is determined to be the NDPA frame.

The user ID information setting unit may include an ID value identifying unit to identify an ID value of the user ID when the first frame is determined to be the BR-poll frame, and an ID value increasing unit to increase the ID value of the user ID information based on a predetermined value.

The at least one reception terminal may be included in a single MU-MIMO group.

The first frame transmitter may include an NDPA frame transmitter to transmit the NDPA frame to a first reception terminal of the at least one reception terminal based on the user ID information, and a BR-poll frame transmitter to transmit the BR-poll frame to a remaining reception terminal of the at least one reception terminal based on the user ID information.

The first frame type determiner may include a sounding protocol terminator to terminate a sounding protocol when the first frame is determined to differ from the NDPA frame and the BR-poll frame.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a media access control (MAC) layer of a wireless local area network (WLAN) according to an example embodiment;

FIG. 2 is a flowchart illustrating a method of transmitting data in a WLAN supporting a multi-user multiple-input and multiple-output (MU-MIMO) according to an example embodiment;

FIG. 3 is a diagram illustrating an example of a method of transmitting data in a WLAN supporting a MU-MIMO according to an example embodiment; and

FIG. 4 is a block diagram illustrating a user identification (ID) information mapping system in a MAC hardware layer according to an example embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

FIG. 1 is a diagram illustrating a media access control (MAC) layer 120 of a wireless local area network (WLAN) according to an example embodiment.

Referring to FIG. 1, the MAC layer 120 of the WLAN may be included in a data link layer, and connect a logical link control (LLC) layer 110 and a physical (PHY) layer 130. Here, the LLC layer 110 may be included in the data link layer, and perform a function of providing a reliable network environment to a network layer, for example, an upper layer of the LLC layer 110, using a data flow control and the like. The PHY layer 130 may perform a function of transmitting and receiving signals of various physical media connected to a network. The MAC layer 120 may include a MAC layer management element (MLME) layer 121, a MAC software layer 122, a transmission queue layer 123, and a MAC hardware layer 124. For example, the MAC layer 120 transmit, to the PHY layer 130, a user ID information indicating an ordinal number of a reception terminal of at least one reception terminal, a number of space time streams (Nsts) to be used for a corresponding reception terminal, and a beamforming parameter for the corresponding reception terminal. The MAC software layer 122 may receive a MAC service data unit (MSDU) frame from the LLC layer 110. Also, the MAC software layer 122 may transmit a MAC protocol data unit (MPDU) frame to the MAC hardware layer 124 using the transmission queue layer 123. The MAC hardware layer 124 may convert the transmitted MPDU frame into a physical layer service data unit (PSDU) frame and transmit the converted PSDU frame to the PHY layer 130. In this instance, the MLME layer 121 may perform a function of managing the MAC software layer 122. The MLME layer 121 may provide a MAC address of the reception terminal, and the MAC address may include information for use in determining the user ID information. However, determining the user ID information and transmitting the beamforming parameter may need to be performed in a short interframe space (SIFS) interval of a sounding protocol. Here, the sounding protocol is a protocol used for acquiring channel information on the reception terminal by a transmission terminal. In 802.11 ac, the SIFS interval may be 16 microseconds (μs), and 16 μs may be insufficient for determining the user ID information in the MLME layer 121. Although the user ID information may be determined in the MAC hardware layer 124, a mapping table between the MAC address and the user ID information may be required to determine the user ID information based on the MAC address. However, a relatively large amount of memory may be required to incorporate the mapping table in the MAC hardware layer 124.

FIG. 2 is a flowchart illustrating a method of transmitting data in a WLAN supporting an MU-MIMO according to an example embodiment.

Referring to FIG. 2, in operations 210 and 211, a type of a first frame to be transmitted to at least one reception terminal may be determined in the method of transmitting data in a WLAN supporting an MU-MIMO. Hereinafter, the method of transmitting data in a WLAN supporting an MU-MIMO may be also referred to as a data transmission method. For example, the MU-MIMO may be based on transmit beamforming technology, and require a beamforming parameter of a reception terminal for data transmission. To utilize the transmit beamforming technology, the transmission terminal, for example, a beamformer, may acquire channel information on the at least one reception terminal, for example, a beamformee. In this instance, the reception terminal may be included in a single MU-MIMO group. The transmission terminal may acquire the channel information on the at least one reception terminal using a sounding protocol. In the sounding protocol, the reception terminal may transmit a first frame to the at least one transmission terminal, and receive a second frame from the at least one reception terminal in response. Subsequent to termination of the sounding protocol, the reception terminal may acquire the channel information on a corresponding reception terminal using the second frame.

For example, in the data transmission method, the type of the first frame may be determined before the first frame is transmitted to the first terminal in the sounding protocol. Here, the first frame may be one of a beamforming report (BR)-poll frame and a null data packet announcement (NDPA) frame included in the sounding protocol. The NDPA frame may be a frame to be transmitted to the reception terminal before a null data packet (NDP) frame is transmitted. Also, the NDPA frame may include information associated with a reception terminal available for reception and information associated with a reception terminal, requiring an initial response of the at least one reception terminal. The BR-poll frame may set a remaining reception terminal of the at least one reception terminal, aside from a first reception terminal, to be a reception address, and transmit to each remaining reception terminal. However, the NDPA frame and the BR-poll frame may not include the user ID information indicating an order of the at least one reception terminal.

In operation 210, whether the type of the first frame corresponds to the NDPA frame may be determined. When the type of the first frame corresponds to the NDPA frame, an ID value of the user ID information may be set to be “0”. When the type of the first frame does not correspond to the NDPA frame, whether the type of the first frame corresponds to the BR-poll frame may be determined in operation 211. When the type of the first frame corresponds to the BR-poll frame, the ID value of the user ID information may be increased based on a predetermined value. When the first frame corresponds to neither the NDPA frame nor the BR-poll frame, the sounding protocol may be terminated.

In operation 220 and operation 221, the user ID information indicating an order of the at least one reception terminal may be set based on a result of the determining. For example, the user ID information may be salient information to be transmitted to a PHY layer by a MAC layer. The user ID information may be determined in a MAC hardware layer using frames transmitted and received in the sounding protocol rather than using the mapping table between a MAC address and a user ID.

In operation 220, when the first frame determined to be the NDPA frame, the ID value of the user ID information may be set to be “0”. Setting “0” as the ID value of the user ID information may indicate a first reception terminal of the at least one reception terminal. In operation 221, when the first frame is determined to be the BR-poll frame, the ID value of the user ID information may be identified, and the ID value of the user ID information may be increased based on a predetermined value. In an example embodiment, the predetermined value may be set to be “1”. Thus, when the at least one reception terminal receives the BR-poll frame, the ID value of the user ID information may be identified, and the ID value of the user ID information may be increased by “1”. As an example, when a single MU-MIMO group includes three reception terminals, the NDPA frame may be transmitted to the first reception terminal, in this example, a reception terminal 1, and the BR-poll frame may be transmitted to a reception terminal 2 and a reception terminal 3. In this case, in operation 220, the ID value of the user ID information of the reception terminal 1 may be set to be “0”. In operation 221, an ID value of user ID information of the reception terminal 2 may be increased by a value of “1” as compared to the ID value of the user ID information of the reception terminal 1 and thus, the ID value of user ID information of the reception terminal 3 may be set to be “1”.

In operation 230, the first frame may be transmitted to the at least one reception terminal corresponding to the user ID information. For example, the order of the at least one reception terminal may be acquired based on the user ID information. Also, the NDPA frame may be transmitted to the first reception terminal of the at least one reception terminal. The BR-poll frame may be transmitted to a remaining reception terminal of the at least one reception terminal, aside from the first reception terminal. Thus, the user ID information may be set without use of the mapping table, and the first frame may be transmitted to the reception terminal corresponding to the user ID information based on the user ID information.

In operation 240, a second frame corresponding to the first frame may be received from the at least one reception terminal. Here, the second frame may be a BR frame included in the sounding protocol. For example, the at least one reception terminal may generate the BR frame in response to the BR-poll frame or the NDPA frame received by the transmission terminal. Here, the BR frame may include a frame control field, a duration field, a destination address (DA) field, a source address (SA) field, a service set identifier (SSID) field, a sequence control field, a frame body field, a frame check sequence (FCS) field, and the like. The BR frame may include channel information, for example, a beamforming parameter of each reception terminal. However, the BR frame may not include the user ID information indicating the order of the at least one reception terminal. Thus, the user ID information may be determined based on the type of the first frame in the MAC hardware layer, rather than acquired from an external area.

In operation 250, the beamforming parameter of the at least one reception terminal may be extracted based on the received second frame. The second frame may include channel information, for example, a beamforming parameter of each reception terminal. In the PHY layer, the reception terminal and a signal may be transmitted and received based on the beamforming parameter of each reception terminal.

In operation 260, the beamforming parameter and the user ID information corresponding to the at least one reception terminal may be transmitted to the PHY layer. For example, signals of various physical media connected to a network including the at least one reception terminal may be transmitted and received in the PHY layer. Thus, the user ID information and the beamforming parameter may be transmitted to the PHY layer. Also, in the PHY layer, an ordinal number of a corresponding reception terminal of the at least one reception terminal may be identified based on the user ID information and the beamforming parameter, and data to be transmitted may be transmitted to the identified reception terminal.

FIG. 3 is a diagram illustrating an example of a data transmission method in a WLAN supporting a MU-MIMO according to an example embodiment.

Referring to FIG. 3, a transmission terminal 310, a reception terminal 1 320, a reception terminal 2 330, and a reception terminal 3 340 may transmit and receive a first frame and a second frame in a sounding protocol, and expressed by a graph on which an X axis indicates a time axis. Here, the sounding protocol may refer to a protocol that may be used by a transmission terminal to acquire channel information on reception terminals. For example, the transmission terminal 310, the reception terminal 1 320, the reception terminal 2 320, and the reception terminal 340 may be included in a single MU-MIMO group. The transmission terminal 310 may determine a type of the first frame to be transmitted to the reception terminal 1 320, the reception terminal 2 330, and the reception terminal 3 340, and set a user ID information indicating an order of the reception terminal 1 320, the reception terminal 2 330, and the reception terminal 3 340 based on a result of the determining. For example, when the first frame is determined to be transmitted to the reception terminal 1 320, the transmission terminal 310 may set an ID value of user ID information associated with the reception terminal 1 320 to be “0”. Also, an ID value of user ID information associated with the reception terminal 2 330 may be set to be “1”, and an ID value of user ID information associated with the reception terminal 3 340 may be set to be “2”. The transmission terminal 310 may transmit an NDPA frame 311 to the reception terminal 1 320 based on the user ID information, and in response, receive a BR frame 1 321, which is a second frame, from the reception terminal 1 320 after an SIFS interval elapses. The transmission terminal 310 may transmit a BR-poll 1 frame 312, the first frame, to the reception terminal 2 330 of which the ID value of the user ID information is “1”. In response, the reception terminal 2 330 may transmit a BR frame 2 331 to the transmission terminal 310. Following this pattern, the transmission terminal 310 may transmit a BR-poll 2 frame 313 to the reception terminal 3 340, and receive a BR frame 3 341 from the reception terminal 3 340. Also, a beamforming parameter of each reception terminal of the reception terminal 1 320, the reception terminal 2 330, and the reception terminal 3 340 from the BR frame 1 321 through the BR frame 3 341 and then, transmitted to a PHY layer with the user ID information.

FIG. 4 is a block diagram illustrating a user ID information mapping system in a MAC hardware layer according to an example embodiment.

Referring to FIG. 4, a first frame type determiner 410 may determine a type of a first frame to be transmitted to at least one reception terminal.

A user ID information setting unit 420 may set user ID information indicating an order of the at least one reception terminal based on a result of the determining.

A first frame transmitter 430 may transmit the first frame to the at least one reception terminal corresponding to the user ID information.

A second frame receiver 440 may receive a second frame corresponding to the first frame from the at least one reception terminal.

A beamforming parameter extractor 450 may extract a beamforming parameter of the at least one reception terminal based on the received second frame.

A user ID information and beamforming parameter transmitter 460 may transmit, to a PHY layer, the user ID information and the beamforming parameter corresponding to the at least one reception terminal.

Descriptions provided with reference to FIGS. 1 through 3 may be identically applied to a user ID information mapping system in a MAC hardware layer of FIG. 4 and thus, repeated descriptions will be omitted herein for increased clarity and conciseness.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A data transmission method in a wireless local area network (WLAN) supporting a multi-user multiple-input and multiple-output (MU-MIMO), the method comprising:
determining a type of a first frame to be transmitted to at least one reception terminal;
setting, based on a result of the determining, user identification (ID) information indicating an order of the at least one reception terminal;
transmitting the first frame to the at least one reception terminal corresponding to the user ID information;
receiving, from the at least one reception terminal, a second frame corresponding to the first frame;
extracting, based on the received second frame, a beamforming parameter with respect to the at least one reception terminal; and
transmitting, to a physical (PHY) layer, the user ID information and the beamforming parameter corresponding to the at least one reception terminal.

2. The method of claim 1, wherein the first frame corresponds to one of a beamforming report (BR)-poll frame and a null data packet announcement (NDPA) frame included in a sounding protocol.

3. The method of claim 1, the second frame corresponds to a BR frame included in a sounding protocol.

4. The method of claim 2, wherein the setting comprises setting, when the first frame is determined to be the NDPA frame, an ID value of the user ID information to be “0”.

5. The method of claim 2, wherein the setting comprises identifying, when the first frame is determined to be the BR-poll frame, an ID value of the user ID information, and increasing the ID value of the user ID information based on a predetermined value.

6. The method of claim 1, wherein the at least one reception terminal is included in a single MU-MIMO group.

7. The method of claim 2, wherein the transmitting of the first frame comprises transmitting the NDPA frame to a first reception terminal of the at least one reception terminal based on the user ID information, and transmitting the BR-poll frame to a remaining reception terminal of the at least one reception terminal based on the user ID information.

8. The method of claim 1, wherein the determining comprises terminating a sounding protocol when the first frame is determined to differ from the NDPA frame and the BR-poll frame.

9. A user identification (ID) information mapping system in a media access control (MAC) hardware layer of a wireless local area network (WLAN) supporting a multi-user multiple-input and multiple-output (MU-MIMO), the system comprising:
a first frame type determiner to determine a type of a first frame to be transmitted to at least one reception terminal;
a user ID setting unit to set user ID information indicating an order of the at least one reception terminal based on a result of the determining;
a first frame transmitter to transmit the first frame to the at least one reception terminal corresponding to the user ID information;
a second frame receiver to receive a second frame corresponding to the first frame from the at least one reception terminal;
a beamforming parameter extractor to extract a beamforming parameter with respect to the at least one reception terminal based on the received second frame; and
a user ID information and beamforming parameter transmitter to transmit, to a physical (PHY) layer, the user ID information and the beamforming parameter corresponding to the at least one reception terminal.

10. The system of claim 9, wherein the first frame corresponds to one of a beamforming report (BR)-poll frame and a null data packet announcement (NDPA) frame included in a sounding protocol.

11. The system of claim 9, wherein the second frame corresponds to a BR frame included in a sounding protocol.

12. The system of claim 10, wherein the user ID information setting unit sets an ID value of the user ID information to be “0” when the first frame is determined to be the NDPA frame.

13. The system of claim 10, wherein the user ID information setting unit comprises an ID value identifying unit to identify an ID value of the user ID when the first frame is determined to be the BR-poll frame, and an ID value increasing unit to increase the ID value of the user ID information based on a predetermined value.

14. The system of claim 9, wherein the at least one reception terminal is included in a single MU-MIMO group.

15. The system of claim 10, the first frame transmitter comprises an NDPA frame transmitter to transmit the NDPA frame to a first reception terminal of the at least one reception terminal based on the user ID information, and a BR-poll frame transmitter to transmit the BR-poll frame to a remaining reception terminal of the at least one reception terminal based on the user ID information.

16. The system of claim 9, wherein the first frame type determiner comprises a sounding protocol terminator to terminate a sounding protocol when the first frame is determined to differ from the NDPA frame and the BR-poll frame.
